(19) United States
(12) Patent Application Publication
(10) Pub. No.: US 2012/0095808 A1
(43) Pub. Date: Apr. 19, 2012

(54) System and Method for Process Predictive Simulation

(75) Inventors: James Kattapuram, Trabuco Canyon, CA (US); David Bluck, Yorba Linda, CA (US)

(73) Assignee: INVENSYS SYSTEMS INC., Foxboro, MA (US)

(21) Appl. No.: 12/906,070

(22) Filed: Oct. 15, 2010

(51) Int. Cl. G06Q 10/00

(52) U.S. Cl. 705/7.37

(57) ABSTRACT

A system for process control is provided. The system comprises a computer system, a data store comprising a plurality of data sets, each data set associated with operating conditions of a plant at a particular time, a first application, and a second application, the first and second applications executed by the computer system. The first application simulates operation of the plant in accordance with first principles and based on one of the data sets. The second application receives plant simulation data from the first application, aggregates plant historical data about the plant from a plurality of sources, associates the plant simulation data and the plant historical data to components of the plant, analyzes the plant simulation data and the plant historical data, and visually presents an information produced by the analysis of the plant simulation data and the plant historical data.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Industrial plants include a wide variety of complex and expensive machinery, materials, and systems. Industrial plants, when failures occur, may injure or kill workers and may damage the environment. Industrial plants may include oil refineries, chemical processing plants, glass fabrication plants, plants to purify metals out of ores, food processing plants, power generation plants, and other plants. A variety of automation initiatives have focused on industrial plants to make them more efficient and to increase their safety, but innovation continues in this space.

### SUMMARY

In an embodiment, a system for process control is disclosed. The system comprises a computer system, a data store comprising a plurality of data sets, each data set associated with operating conditions of a plant at a particular time, a first application, and a second application, the first and second applications executed by the computer system. The first application simulates operation of the plant in accordance with first principles and based on one of the data sets. The second application receives plant simulation data from the first application, aggregates plant historical data about the plant from a plurality of sources, associates the plant simulation data and the plant historical data to components of the plant, analyzes the plant simulation data and the plant historical data, and visually presents an information produced by the analysis of the plant simulation data and the plant historical data.

In an embodiment, a system for process control is disclosed. The system comprises a computer system and a data store comprising a plurality of data sets, each data set associated with a plant at a particular time. The system further comprises an enterprise manufacturing intelligence (EMI) application that, when executed by the computer system, aggregates a plurality of historic data from a plurality of sources, at least some of the historic data stored in the data store, contextualizes the historic data by associating at least some of the historic data to components of the plant, analyzes at least some of the historic data and a plurality of simulation data to determine the economic value of a change of the plant from a current actual state of the plant represented by the simulated data, and presents the economic value of the change. The system further comprises a first principles plant simulation application that, when executed by the computer system, produces the simulation data based at least in part on the change of the plant from a current actual state of the plant.

In an embodiment, a method of operating a plant is disclosed. The method comprises storing a first historical data set in a data store, the first historical data set representing at least in part an operating state of the plant and aggregating historical data from a plurality of sources, the sources comprising the data store. The method further comprises providing a context for the historical data by associating at least some of the historical data with one of the components in the plant or units of measurement and simulating the plant to produce a simulated data set representing at least in part a simulated operating state of the plant, the simulating based on at least some of the historical data and based on changing an at least one operating parameter of the plant. The method further comprises analyzing some of the historical data and the simulated data set to determine a result of changing at least one operating parameter and presenting the result of changing at least one operating parameter.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a system according to an embodiment of the disclosure.

FIG. 2 is a flow chart of a method according to an embodiment of the disclosure.

FIG. 3 illustrates an exemplary computer system suitable for implementing the several embodiments of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

A system and method for predictive simulation of one or more industrial plants is disclosed. Data about the plant is aggregated from one or more sources, the data is contextualized, analyzed, presented, and propagated to users of the data. It is understood that during this process the data may be transformed and/or reformatted. Additionally, new data may be generated based in part on the data about the plant. Simulation of the plant or portions of the plant using first principles models of plant components and dynamic processes of the plant components are fed into the analysis to provide the ability to analyze hypothetical plant states, to predict future plant states, and to evaluate the desirability of alternative plants states.

The hybrid data formed by combining the data aggregated from one or more sources and the simulated plant data may be used for a variety of purposes, including training a plant operator, practicing procedures for responding to equipment malfunctions and/or breakdowns, and predicting the future result of a current plant set point adjustment. The hybrid data may be used to automatically determine properties of plant components that may not be directly measurable, for example an accumulation of scaling on an interior of a heat exchanger that decreases the heat transfer function of the heat exchanger. The hybrid data may be used by plant designers to evaluate a design of a different but related industrial plant design.

The system and method for predictive simulation may be used to share insights across a plurality of related plants, for example a plurality of oil refineries. The system and method may be used to analyze a variety of “what if?” scenarios. The system and method for predictive simulation may be used to distribute and uniformly impose safety policies such as design safety factors on operators of different plants at different locations.

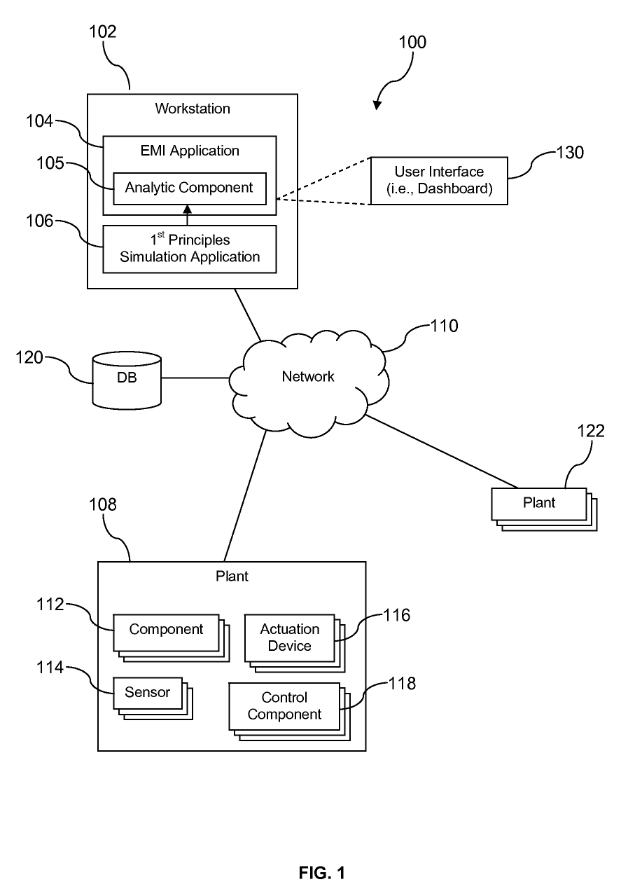

Turning now to FIG. 1, a system 100 is described. In an embodiment, the system 100 may comprise a workstation 102 that executes an enterprise manufacturing intelligence (EMI) application 104 and a first principles simulation application 106. In an embodiment, the EMI application 104 may comprise an analytic component 105. The workstation 102 is coupled to a first plant 108 via a network 110. The first plant 108 may comprise one or more components 112, one or more sensors 114, one or more actuation devices 116, and one or more control components 118. The first plant 108 may comprise other components that are not depicted in FIG. 1. In an embodiment, the workstation 102 may be coupled via the network 110 to additional plants 122 that may likewise comprise components 112, sensors 114, actuation devices 116, control components 118, and other components. The workstation 102 may be coupled via the network 110 to one or more data stores 120. It is understood that in some embodiments, the system 100 may differ from the structure depicted in FIG. 1 in some details.

The network 110 may comprise one or more public communication networks, one or more private communication networks, or combinations thereof. The network 110 may comprise one or more local area networks (LANs), wide area networks (WANs), the Internet, the public switched telephone network (PSTN), a mobile wireless communication network, and other networks. The communication equipment comprising the network 110 represented abstractly by the cloud shape in FIG. 1 may be located anywhere—some communication equipment may be located in the plants 108, 122, some communication equipment may be located in a headquarters facility separate from the plants 108, 122, some communication equipment may be located in a communication service provider domain, and other communication equipment may be located elsewhere.

In an embodiment, the plants 108, 122 may provide similar functions. For example, the plants 108, 122 may all be directed to refining crude oil into products such as gasoline, diesel fuel, jet fuel, kerosene, and the like. As another example, the plants 108, 122 may all be directed to processing grain and other materials into breakfast cereal. Alternatively, in an embodiment, at least two of the plants 108, 122 may provide different functions. For example, the first plant 108 may refine crude oil into products while the additional plants 122 may generate power, for example electrical power.

The components 112 may be any of a variety of devices. The components 112 may comprise heat exchangers, boilers, turbines, distillation columns, fractionating columns, condensers, electric motors, electric generators, pumps, ovens, conveyors, mixers, and a wide variety of other components. Some of the components 112 may be coupled to one another to promote fluid flow for example via piping, for example liquid flow and/or vapor flow. Other components 112 may be mechanically coupled to one another to transfer signals and/or to transfer mechanical energy. Other components 112 may be electrically coupled to one another to transfer signals and/or to transfer electrical energy. Other components 112 may be thermally coupled to one another to transfer signals and/or to transfer thermal energy.

The components 112 may be associated with one or more properties and/or parameters that may be sensed by the sensors 114. For example, a pressure of a fluid in a boiler may be sensed by a first sensor 114, and a temperature of the fluid in the boiler may be sensed by a second sensor 114. The components 112 may be coupled to and/or associated with one or more actuation devices 116. For example, a steam turbine may be coupled to a high pressure steam inlet valve whose position is controlled by an electric motor, wherein the high pressure steam inlet valve combined with the electric motor may be considered to comprise an actuation device 116. As another example, an oven may comprise an electric resistive heater element whose electric power delivery is controlled by a thyristor device, wherein the electric resistive heater element combined with the thyristor device may be considered to comprise an actuation device 116.

The control components 118 may be any of a variety of control devices, either electronic, mechanical, or electromechanical. Control components 118 may comprise one or more distributed control systems (DCSs), one or more programmable logic controllers (PLCs), and other intelligent electronic control devices. The control components 118 may include non-electronic control devices, for example bimetallic thermostat switches. A control component 118 may be coupled to at least one actuation device 116 whereby a property and or parameter of a component 112 is controlled. The control component 118 may be coupled to a sensor 114 and may control the actuation device 116 and/or the component 112 based on a sensed value of a property and/or parameter of the component 112 provided by the sensor 114. The control component 118 may control the actuation device 116 and/or the component 112 based on other information, for example based on a commanded value received from another control component 118 and/or from the workstation 102.

The control component 118 may control the component 112 by repeatedly calculating or other wise determining a control output to control the component 112, for example by sending the control output to the actuation device 116. The control component 118 may repeatedly determine the control output at a periodic rate, for example about every millisecond, about every 100 milliseconds, about every second, about every ten seconds, or some other periodic interval. Alternatively, the control component 118 may determine the control output aperiodically, for example responsive to received events. In the circumstance that the control component 118 controls a plurality of components 112, the control component 118 may send a periodic control output to a first actuation device 116 coupled to a first component 112 and may send an aperiodic control output to a second actuation device 116 coupled to a second component 112. It is understood that the plants 108, 122 may be highly complex systems.

The data store 120 may store values of operating parameters and system properties of the plants 108, 122 associated with different time stamps. In an embodiment, a time stamp may be part of each stored value. Alternatively, in an embodiment, the stored values may not have an explicit time stamp stored with the value, but rather the values are stored in sequence with a known time offset between each subsequent value, whereby a time associated with any value in the sequence may be inferred based a known start time of the sequence, based on the position of the value in the sequence, and based on the time offset between each subsequent value. The control components 118 may transmit the values of the operating parameters and system properties to the data store 120 via the network 110. Alternatively, the EMI application 104 may retrieve the values of the operating parameters and system properties from the plants 108, 122 via the network 110 and write them to the data store 120. In an embodiment, the EMI application 104 may implement a historian service or historian application that mediates storage of the values of the operating parameters and system properties to the data store 120. Alternatively, a historian application that mediates storage of the values of the operating parameters and system properties to the data store 120 may execute on a separate computer other than the workstation 102.

The values stored in the data store 120 may be formatted in a variety of different formats. For example, the values may be stored in spreadsheet format, in database table format, in extensible markup language (XML) file format, and other formats. At least some of the values stored in the data store 120 may comprise a time stamp indicating a time at which the value was determined, for example the time when a temperature of steam at the inlet of a high pressure turbine. The values stored in the data store 120 may comprise time sequences of a value associated with the same parameter or system property, for example a time sequence of values of the temperature of the steam at the inlet of the high pressure turbine. In an embodiment, the historian application may perform various housekeeping tasks, for example deleting aged data from the data store 120 and/or writing aged data to an archival storage device (not shown).

The EMI application 104 and the first principles simulation application 106 may execute on any computer system. Computer systems are discussed in greater detail hereinafter. In an embodiment, the EMI application 104 and the first principles simulation application 106 may execute on the workstation 102, for example a personal computer, a laptop computer, or other single user computer. While a single workstation 102 is illustrated in FIG. 1, it is understood that multiple workstations 102 may coexist in the system 100.

The EMI application 104 may provide data aggregation, contextualization of data, data analysis, data visualization, and data propagation. Data aggregation refers to the collection of data from a variety of disparate sources, for example data stored in disparate formats as well as data located in different places. For example the data may be located in different databases or located at different plants 108, 122.

Contextualization as used herein refers to associating a data item with one of the components 112, one of the sensors 114, one of the actuation devices 116, and/or one of the control components 118 of the plant 108, 122. Contextualization further refers to associating a suitable unit to the subject value of the data items. In an embodiment, it may be possible for a user of the workstation 102 to select a desired unit. Contextualization may comprise identifying a first data element named T(13) as a high pressure turbine inlet temperature and a second data element named T(17) as a high pressure turbine outlet temperature. As an example, contextualization may comprise associating the units degrees Celsius with the first and second data elements. The contextualization functionality of the EMI application 104 may support changing the units associated with data elements, for example changing the representation of the value of the first data element T(13) to degrees Fahrenheit, including appropriate conversion of the temperature value from the degrees Celsius unit system to the degrees Fahrenheit unit system.

Data analysis may include a wide variety of operations performed on the data including data smoothing, data filtering, data merging, data correlation, statistical analysis of the data, drawing inferences from the data. In part, the data analysis may comprise processing values projected or output by the first principles simulation application 106. The merging of historical data with simulation data may be referred to as hybrid data. Data visualization may comprise presenting one or more of the data items in a manner that is selected and/or configured by the user of the workstation 102. The data items may be represented as a function of time. The data items may be projected into the future based on historical values to represent a trend. The data may be represented as a histogram of values. The data that is produced by the data analysis function may be propagated, for example sent via the network 110, to other stake holders, for example managers, quality assurance workers, safety monitors, and others. The EMI application 104 may provide a user interface 130 for receiving user control inputs to operate the functions of the EMI application 104 as well as for outputting signals to present the displays of the data and/or data items. The user interface 130 may be referred to in some contexts as a dashboard.

The first principles simulation application 106 may take a variety of forms depending on the nature of the plant 108, 122. For example, the first principles simulation application 106 for a food processing plant may exhibit notable differences from the first principles simulation application 106 for a crude oil refinery. Independently of the nature of the plant 108, 122, the first principles simulation application 106 fits a mathematical model to the plant 108, 122. The first principles simulation application 106 may execute algorithms to model the components 112, sensors 114, actuation devices 116, and control components 118 that make up the subject plant 108 based on mathematical models.

For example, a mixing tank may be represented by a mathematical model comprising an equation relating inflow rate of a first fluid having a first density into a first divided portion of the mixing tank, an inflow rate of a second fluid having a second density into the first divided portion of the mixing tank, and an outflow rate of a mixed fluid out of a second divided portion of the mixing tank. This exemplary mathematical model may embed constants representing physical attributes of the mixing tank such as a volume of the first divided portion of the mixing tank, a volume of the second divided portion of the mixing tank. This exemplary mathematical model may be configured with initial values of some system parameters such as a height of the mixed fluid in the first divided mixing tank and a height of the mixed fluid in the second divided mixing tank. The mathematical model may make some assumptions such as that the mixed fluid is homogenous (“perfect mixing” assumed) and that the first divided mixing tank is full and overflows into the second divided mixing tank. The mathematical model may determine simulated values of parameters of interest for example the density of the mixed fluid and hence the density of the fluid flowing out of the second divided portion of the mixing tank, the height of the mixed fluid in the second divided portion of the mixing tank. The mathematical model typically incorporates scientific and/or engineering principles, for example Newton's second law: force is proportional to mass times acceleration.

A series of components in the plant 108 may be represented by flowing the results of a first mathematical model to the inputs of a second mathematical model, for example a third component 112 that outputs fluid to a fourth component 112. The complete aggregate mathematical model may be iteratively recalculated to converge on a consistent determination of the values, parameters, and properties modeled by the mathematical model. This may be referred to in some contexts as simulating a steady state of the plant 108, and the mathematical model may be referred to as a steady state model.

In another embodiment, the complete aggregate mathematical model may be iteratively recalculated to take account of changing system inputs and to determine a succession of operating states of the plant 108. For example, in an embodiment the aggregate mathematical model is recalculated periodically to achieve a dynamic simulation of the plant 108 and/or portions of the plant 108. In combination with the present disclosure the rate of iteration may be determined by one skilled in the art to achieve the fidelity of dynamic simulation desired. In an embodiment, the mathematical model may be partitioned into different model components that may be iteratively recalculated at different rates to manage the processing load placed on a computer system hosting the dynamic simulation.

The first principles simulation application 106, in combination with the analytic component 105 of the EMI application 104, may be used to analyze the result of changing some control inputs to the plant 108, for example changing one or more operating points. For example, the first principles simulation application 106 may simulate a reduced in-flow of crude oil, an increased heat transfer to a component 112, and calculate a total economic result of the changed distribution of products of refining based on current and/or projected market pricing of the products. The first principles simulation application 106 may be used to train an operator of the plant 108, for example providing a simulation of the effects of changing one or more controls on a variety of parameters and/or properties associated with components 112 throughout the plant 108. The first principles simulation application 106 in combination with the analytic component 105 may be used to evaluate a plant design and/or to evaluate a component design.

The first principles simulation application 106 may be used to forecast a future steady state of the plant that would result from one or more changes to controls. This capability may be useful in handling an emergency at a plant where alternative responses to the emergency are possible but the outcomes of the different responses are not known in advance. The first principles simulation application 106 may simulate the operation of the plant 108 based on a plurality of different control vectors to identify one control vector that provides the best economic result. The best economic result may be associated with one or more of the highest absolute return, the highest return on investment, the greatest profit margin, or other economic performance metric.

The first principles simulation application 106 in combination with the analytic component 105 may be used to analyze the cost of continuing to operate a degrading component 112 versus the cost of replacing and/or performing maintenance on the degrading component 112. The first principles simulation application 106 in combination with the analytic component 105 may determine a value of a parameter or property of the component 112 that is not suitable for measurement. For example, based on current and/or stored data, the accumulation of scaling on the interior of a heat exchanger may be calculated, a rate of change of scaling on the interior of the heat exchanger may be determined, the future economic value of operating the plant 108 leaving the heat exchanger as is and continuing to accumulate internal scaling may be simulated, the future economic value of operating the plant 108 using a new heat exchanger may be simulated, the future economic value of maintaining the heat exchanger by removing the scaling and operating the plant 108 using the maintained heat exchanger may be simulated, and an informed choice may be made between leaving the heat exchanger as is, maintaining the heat exchanger, and replacing the heat exchanger.

The first principles simulation application 106 in combination with the analytic component 105 may be used to analyze the impact of inaccurate sensors on the aggregate economic value of operating the plant 108. The values output by sensors 114 may be used by the control components 118 to maintain the operating point of the plant 108. To the extent the sensors 114 output inaccurate values, the plant 108 may achieve diminished economic results. Sensors 114 may be periodically recalibrated, maintained, and/or replaced on a standard interval. It is contemplated that it may be possible to determine the economic sensitivity of operating the plant 108 associated with the inaccuracy of specific sensors 114. Determining the economic sensitivity of operating the plant 108 of specific sensors 114 may promote replacing and/or maintaining some sensors 114 at a different rate or on a different schedule than other sensors 114.

The first principles simulation application 106 in combination with the analytic component 105 may be used to analyze a hypothetical operating point of the plant 108. For example, the economics of processing a tanker load of crude oil offered on the spot market at a specific refinery may be determined based on data stored in the data store 120 and based on simulation by the first principles simulation application 106. The data store 120 may be searched to select data associated with the subject refinery refining a crude oil feedstock that suitably matches the crude oil feedstock offered for sale on the spot market. Some of the selected data may be input into the mathematical models in the first principles simulation application 106, and the economics of refining the tanker load of crude oil may be simulated based on current market prices of the refined products, based on seasonal constraints such as gasoline recipes for summer consumption, based on regulatory constraints.

It will be readily appreciated by those skilled in the art that there may be significant differences between results predicted based on projecting past data associated with the plant 108 as trends into the future and results predicted based on a simulation using a first principles math model of the plant 108. It may be difficult to predict the impact of changes of current conditions from conditions that prevailed when the historic data of past operation of the plant 108 were collected, because the relationships involved are non-linear and perhaps chaotic. In some cases, the results of simulating the plant 108 may provide counterintuitive guidance, for example to reduce both the in-flow of crude oil into a refinery and to reduce the outflow of refined products to achieve improved economic results under a specific set of circumstances. It may be unlikely that an analyst would have the conviction to persuade management to dial back refinery flow through to achieve improved economics without the support from the results of simulation according to first principles. Additionally, it is possible that analysis based only on projecting historical data forwards inherently embeds constraining assumptions that excludes otherwise viable plant operating options from consideration.

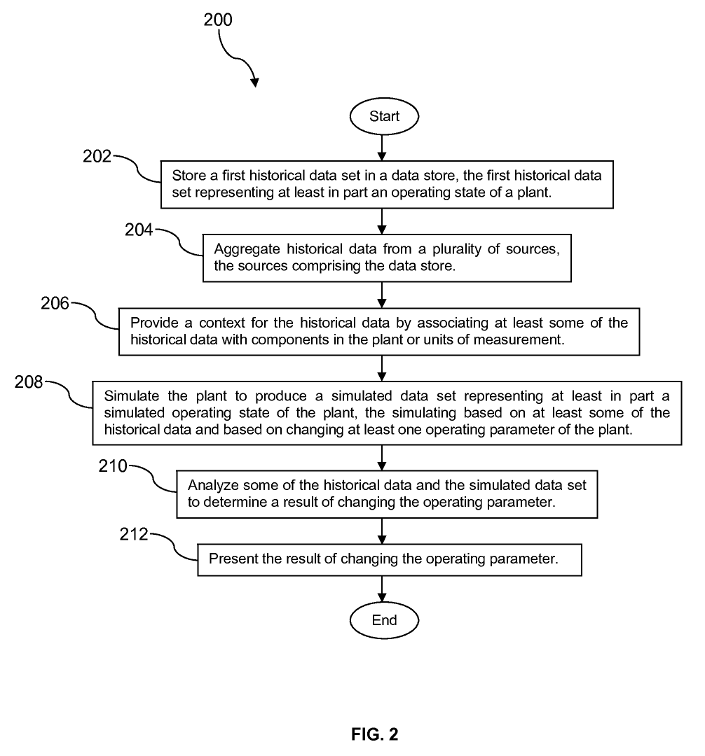

Turning now to FIG. 2, a method 200 is described. The method 200 begins at block 202 where a first historical data set is stored in a data store, the first historical data set representing at least in part an operating point of the plant 108. The first historical data set may be stored in the data store 120. The processing of block 202 may further comprise storing a first historical data set for each of the additional plants 122 in the data store 120. The historical data set may comprise sensed parameter and/or property values output by one or more of the sensors 114. The historical data set may further comprise values of control signals output by one or more of the control components 118. In an embodiment, parameter and/or property values of different sensors 114 may be collected and stored in the data store 120 at different times and/or at different periodic rates.

At block 204, historical data is aggregated from a plurality of sources, the sources comprising the data store 120. The sources may comprise other sources as well, for example including one or more of the control components 118 and/or one or more of the additional plants 122. The sources may comprise historical data stored in other data stores and/or data bases. Additionally, the historical data may be stored in different data formats. For example, some of the historical data may be stored in spread sheet files; some of the historical data may be stored in extensible markup language (XML) formatted files; some of the historical data may be stored in data tables in structures defined by one or more data base schemas.

At block 206, a context for the historical data is provided by associating at least some of the historical data with components 112 in the plant 108 or with units of measurement. As an example, a first historical data is contextualized by identifying it as the temperature of steam at the inlet of a high pressure turbine having a temperature of 1000 degrees Fahrenheit. In an embodiment, the processing of block 206 may be performed in accordance with user inputs provided by the user interface 130, for example an input selecting a set of preferred units. Thus, the user may select to display temperatures in units of degrees Celsius, and the temperature of steam at the inlet of the high pressure turbine may be contextualized as 538 degrees Celsius.

At block 208, the plant 108 is simulated to produce a simulated data set representing at least in part a simulated operating state of the plant 108, the simulating based on at least some of the historical data and based on changing at least one operating parameter of the plant 108. At block 210, some of the historical data and the simulated data set are analyzed to determine a result of changing the operating parameter of the plant 108. As an example, the operating parameter of the plant 108 that is changed may be a rate of heat transfer of a heat exchanger (turning up the rate of fuel feed to a heater), a position of a steam inlet feed valve incrementally, a commanded pump flow rate, and other operating parameters. At block 212, the result of changing the operating parameter is presented, for example presented on the user interface 130. The result of changing the operating parameter may be another operating parameter of the plant 108. Alternatively, the result of changing the operating parameter may be an economic operational metric of the plant 108.

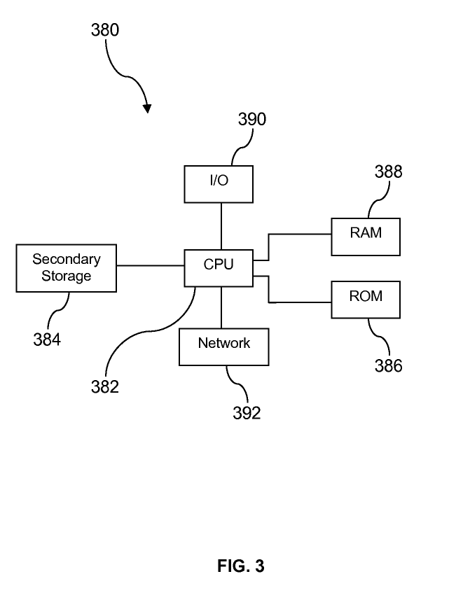

FIG. 3 illustrates a computer system 380 suitable for implementing one or more embodiments disclosed herein. The computer system 380 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as non-transitory storage and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embodied in the carrier wave generated by the network connectivity devices 392 may propagate in or on the surface of electrical conductors, in coaxial cables, in waveguides, in an optical conduit, for example an optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, may be generated according to several methods well known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein implementing the functionality disclosed above. The computer program product may comprise data, data structures, files, executable instructions, and other information. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data in part by directly accessing the computer program product, for example by reading from a CD-ROM disk inserted into a disk drive peripheral of the computer system 380. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A system for process control, comprising:
a computer system;
a data store comprising a plurality of data sets, each data set associated with operating conditions of a plant at a particular time,
a first application that, when executed by the computer system, simulates operation of the plant based at least in part on one of the data sets, wherein the application simulates operation of the plant based on first principles,
a second application that, when executed by the computer system,
receives plant simulation data from the first application,
aggregates plant historical data about the plant from a plurality of sources,
associates the plant simulation data and the plant historical data to components of the plant,
analyzes the plant simulation data and the plant historical data, and
visually presents an information produced by the analysis of the plant simulation data and the plant historical data.

2. The system of claim 1, wherein the second application is an enterprise manufacturing intelligence (EMI) application.

3. The system of claim 1, wherein the plant is one of an oil refinery, a steam powered electrical generation plant, a brewery, and a food processing plant.

4. The system of claim 1, wherein the first application simulates operation of the plant based further on at least one change parameter, where the change parameter is substituted in first principles calculations by the first application in the place of a parameter from one of the data sets.

5. The system of claim 1, wherein the second application visually presents a parameter that is simulated by the first application, wherein the parameter is not directly measured by a sensor of the plant.

6. The system of claim 1, wherein the second application determines the economic value of replacing a component of the plant based on the plant simulation data.

7. The system of claim 1, wherein the second application determines a sensitivity of the analysis based on the plant simulation data.

8. A system for process control, comprising:
a computer system;
a data store comprising a plurality of data sets, each data set associated with a plant at a particular time;
an enterprise manufacturing intelligence (EMI) application that, when executed by the computer system,
aggregates a plurality of historic data from a plurality of sources, at least some of the historic data stored in the data store,
contextualizes the historic data by associating at least some of the historic data to components of the plant,
analyzes at least some of the historic data and a plurality of simulation data to determine the economic value of a change of the plant from a current actual state of the plant represented by the simulated data, and
presents the economic value of the change; and
a first principles plant simulation application that, when executed by the computer system, produces the simulation data based at least in part on the change of the plant from a current actual state of the plant.

9. The system of claim 8, wherein the EMI application contextualizes the historic data further by associating a unit of measure with at least some of the historic data.

10. The system of claim 8, wherein the first principles plant simulation application produces the simulation data based at least in part on calculating thermodynamic properties using at least one equation of state.

11. The system of claim 10, wherein the first principles plant simulation application calculates the thermodynamic properties further using at least one phase equilibrium calculation.

12. The system of claim 8, wherein the change of the plant comprises replacing a component of the plant and wherein determining the economic value of the change is based in part on a cost of the replacement cost of the component.

13. The system of claim 8, wherein the historic data analyzed by the EMI application comprises a data set selected from the data store based on a criteria selected from one of a market price for a precursor material consumed by the plant, a market price for a product produced by the plant, and a seasonal constraint.

14. A method of operating a plant, comprising:
storing a first historical data set in a data store, the first historical data set representing at least in part an operating state of the plant;
aggregating historical data from a plurality of sources, the sources comprising the data store;
providing a context for the historical data by associating at least some of the historical data with one of components in the plant or units of measurement;
simulating the plant to produce a simulated data set representing at least in part a simulated operating state of the plant, the simulating based on at least some of the historical data and based on changing an at least one operating parameter of the plant;
analyzing some of the historical data and the simulated data set to determine a result of changing the at least one operating parameter; and
presenting the result of changing the at least one operating parameter.

15. The method of claim 14, further comprising storing a second historical data set in the data store, the second historical data set representing at least in part an operating state of a second plant.

16. The method of claim 15, wherein changing the at least one operating parameter of the plant is based on the second historical data set.

17. The method of claim 14, wherein the operating parameter is an operational set point of the plant.

18. The method of claim 14, wherein the operating parameter is associated with replacing a component of the plant.

19. The method of claim 14, wherein the plant is one of an oil refinery, a steam cycle electrical power generation plant, a brewery, and a food processing plant.

20. The method of claim 14, wherein the at least one operating condition is one of a market price of a raw material processed by the plant, a market price of a product produced by the plant, and a seasonal parameter.
